(19) United States
(12) Patent Application Publication
(10) Pub. No.: US 2016/0283618 A1
(43) Pub. Date: Sep. 29, 2016

(54) Diffraction Grating Modelling

(71) Applicants: Tapani Levola, Espoo (FI); Pasi Saarikko, Espoo (FI)

(72) Inventors: Tapani Levola, Espoo (FI); Pasi Saarikko, Espoo (FI)

(21) Appl. No.: 14/670,242

(22) Filed: Mar. 26, 2015

(51) Int. Cl. G06F 17/50

(52) U.S. Cl. CPC G06F 17/5009

(57) ABSTRACT

A diffraction grating modelling systems and methods are disclosed. A database comprises a plurality of records, each labelled by a diffraction parameter set that describes a diffraction scenario. A scattering map describes a field transformation induced in that scenario. Various techniques for maintaining and using the database are disclosed.

### BACKGROUND

Visible light is electromagnetic radiation in the visible region of the electromagnetic spectrum, which runs between about 390 and 700 nanometres (nm). An electromagnetic wave (referred to herein simply as a “wave”) is made up of an electric field and a magnetic field. The electric and magnetic fields can be represented as vectors, generally denoted E (“E-field”) and B respectively. Often, it is useful to represent the electric and magnetic fields as 3-dimensional complex-valued vectors E, B (each of which has individual vector components that in turn have both a real and imaginary component, E, B thus having six components in total) e.g. in a manner such that the imaginary part Im(·) or, more conventionally, the real part Re(·) of E (resp. B) corresponds to the observable physical electric (resp. magnetic field) itself. Note that the complex vector representations E, B are sometimes referred to simply as the electric and magnetic fields respectively; it will be clear from the context what is being referred to. The “H-field” is defined as

$$H = \frac{B}{{μ}_{0}} - M$$

where M represents the magnetism of the region in which the wave is propagating (M=0 for non-magnetic regions), and μ₀ is the permeability of free space (vacuum) otherwise referred to as the magnetic constant. The vacuum also has a permittivity ∈₀ otherwise referred to as the electric constant.

The electric and magnetic fields that constitute an electromagnetic wave oscillate over time. As they oscillate, they remain perpendicular both to each other and to the direction in which the wave is propagating. The direction of propagation of the wave can be described by a 3-dimensional (real valued) propagation vector, generally denoted \hat{k}, which can be fully parameterized using two parameters e.g. as a polar-azimuth angle pair θ, φ. The propagation vector \hat{k} is a unit vector i.e. |\hat{k}|=1. The wave has a wave vector defines as

$$k = \frac{2 π}{λ} \hat{k} ,$$

which can fully parameterized using three parameters e.g. θ, φ and λ. The vectors E, B and k relate to one another as B=c₀⁻¹k×E (where c₀ is the speed of light in a vacuum); thus an electromagnetic wave can be completely characterized by (e.g.) its E and k vectors (as these are determinative of its B vector). The intensity of the wave is proportional to [symbol] E*E [symbol] , where [symbol] · [symbol] denotes time averaging and E* is the conjugate transpose of E. The physical electric field (e.g. corresponding to Re(E)) has an orientation, which is called the polarisation of the wave. Thus, the polarization and intensity of the wave can be determined from E alone.

The behaviour of electromagnetic waves is described by Maxwell's equations. For any given structure, it is at least theoretically possible to predict the manner in which light interacting with that structure will be transformed by solving Maxwell's equations for a set of boundary conditions that capture the physical properties of the incident light and the physical properties of the structure itself.

Diffraction occurs when a propagating wave interacts with a structure, such as an obstacle or slit. As indicated, visible light has wavelengths between approximately 390 and 700 nm and diffraction of visible light is most pronounced when propagating light encounters structures of a similar scale e.g. of order 100 or 1000 nm in scale. One example of a diffractive structure is a periodic (substantially repeating) diffractive structure. Diffraction of light by a periodic structure is typically most pronounced when the periodic structure has a spatial period of similar size to the wavelength of the light. Types of periodic structures include, for instance, surface modulations on the surface of an optical component (which define a boundary between two materials of different refractive index), refractive index modulations, holograms etc. Herein, the term “diffraction grating” encompasses any diffractive, periodic structure. A diffraction grating has a period d which is the distance over which the structure of the grating substantially repeats.

When an electromagnetic wave is incident on a diffraction grating, diffraction causes the wave to be split into diffracted electromagnetic waves which propagate in different directions. The physical properties of the diffracted waves—in particular their wavelengths, electric fields and directions of propagation—depend both on the physical properties of the incident wave—in particular, its own wavelength, electric field and direction of propagation—as well as the physical properties of the diffraction grating, in particular the period d of the grating but also on numerous other physical properties of the grating. The physical properties of the diffracted waves can be predicted by solving Maxwell's equations for a suitable set of boundary conditions that capture the physical properties of the incident wave and those of the diffraction grating on which it is incident.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

According to a first aspect a diffraction grating modelling system comprises a database, an input, an access module and an update module. The database comprises a sequence of records. Each record is labelled by a diffraction parameter set (denoted Q in the examples below) which describes a diffraction scenario and comprises a corresponding scattering map (e.g. a scattering matrix or selective components thereof, denoted S below, and R or T in certain examples) which describes a field transformation induced in that scenario. The sequence is ordered by diffraction parameter set. The input is configured to receive an input diffraction parameter set (e.g. Qin, below) which defines a target diffraction scenario. The access module is configured to search the database for a record matching the input set at an expected position in the sequence, and to access the corresponding scattering map when found. The update module is configured, only when no matching record is found, to compute from the input set a scattering map for the target scenario, and to create a new record in the sequence which is labelled by the input set and comprises the computed map. The new record created at the expected position, so that the sequence remains ordered by parameter with the addition of the new record.

According to the second aspect a diffraction grating modelling system comprises a database, an input, an access module, and a transformation module. The database comprises a sequence of records, each labelled by a diffraction parameter set which describes a diffraction scenario in which an incident wave is diffracted and comprising a corresponding scattering map which describes a field transformation induced in that scenario. The diffraction parameter sets set do not specify any fields of the incident waves. The input is configured to receive (i) an input diffraction parameter set which defines a target diffraction scenario in which a target incident wave is diffracted and (ii) input field data which specifies a field of the target incident wave. The access module is configured to search the database using the input set but not the input field data for a record matching the input set, and to access the corresponding scattering map when found. The transformation module configured to use the accessed scattering map to compute from the input field data a field of a diffracted wave created in the target scenario.

According to the second aspect the database is not specific to any specific values of incoming electric and magnetic fields i.e. to polarization. The scattering map has enough information so that the diffraction patterns can be calculated by very simple calculations for any incoming polarization.

According to a third aspect, a computer program product comprises code stored on a computer readable storage medium and configured when executed to implement a diffraction grating modelling method. The method comprises the following steps. An input diffraction parameter set which defines a target diffraction scenario is received, the input diffraction parameter set indicating a target incident unit propagation vector (e.g. \hat{α}₀, below). A target incident field vector for the target scenario is received (e.g. \vec{E}₀, below). A database is accessed. The database comprises comprising a plurality of records, each labelled by a diffraction parameter set which describes a diffraction scenario and comprising a corresponding scattering map which describes a field transformation induced in that scenario, the diffraction parameter set indicating an incident unit propagation vector. A record for which the vector dot product between that record's incident unit propagation vector and the target incident unit propagation vector is maximized is identified. A transformation is applied to the target incident field vector to compute a transformed field vector that is perpendicular to the identified record's incident unit propagation vector. The identified record's scattering map is applied to the transformed field vector to compute an intermediate diffracted field vector. An inverse of the transformation is applied to the intermediate diffracted field vector to compute a diffracted field vector of a diffracted wave that would be created in the target scenario.

The aforementioned fields can be electric or magnetic fields.

According to another aspect, a grating manufacturing process is disclosed, which comprises using any of the modelling systems, methods or computer program products disclosed herein in manufacturing a diffraction grating. For a computer program product, the manufacturing process may comprise executing the computer program product on a computer and using the executed program in manufacturing the diffraction grating.

### BRIEF DESCRIPTION OF FIGURES

FIG. 1 shows an incident plane electromagnetic wave being diffracted by a diffraction grating;

FIG. 1A shows a set of multiple incident place waves being diffracted by a diffraction grating;

FIG. 2 shows a function block diagram of a diffraction grating modelling system;

FIG. 3 shows a flow chart for a method effected by the system of FIG. 2;

FIG. 4A shows an exemplary database of scattering matrices;

FIG. 4B shows the database of FIG. 4A with the addition of a new record.

### DETAILED DESCRIPTION

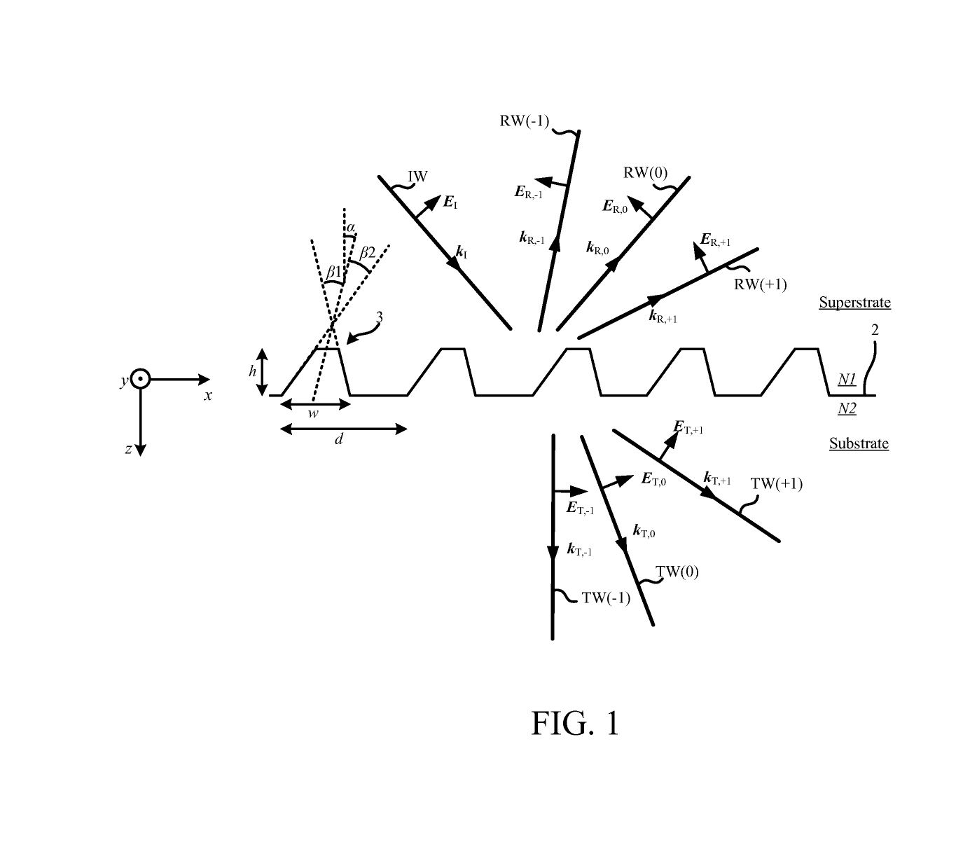

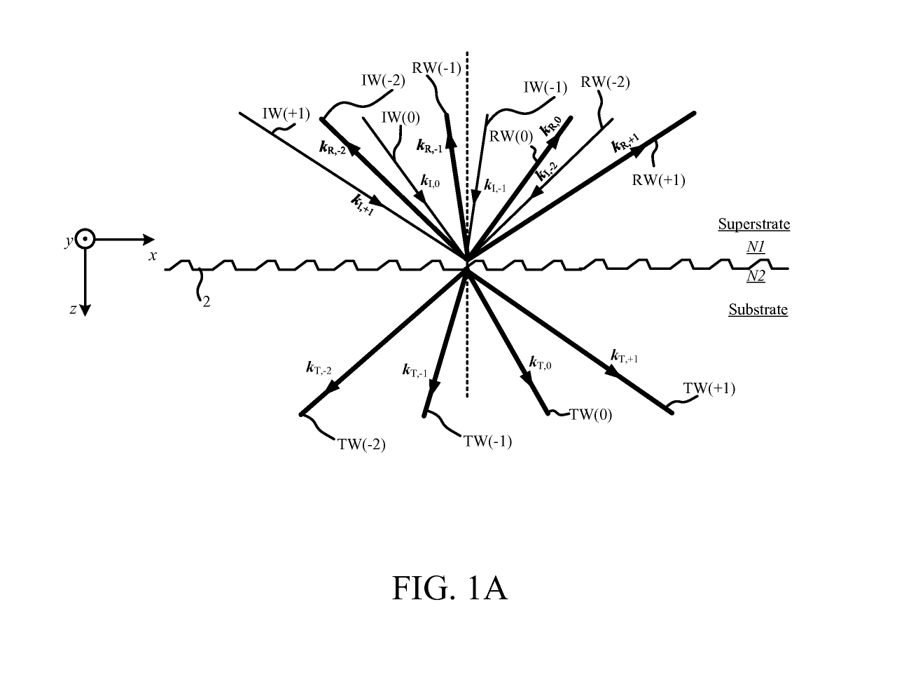

FIG. 1 illustrates a diffraction scenario in which a plane electromagnetic wave IW of wavelength λ_{I} is incident on a two-dimensional diffraction grating 2, which is viewed side-on in FIG. 1. The diffraction grating 2 lies substantially parallel to a plane (xy-plane). The diffraction grating 2 is formed by the boundary between two materials having different refractive indices N1, N2. The boundary between the materials constitutes a spatial waveform having a period d over which the waveform substantially repeats, which is the grating period of the grating 2. The grating has a vertical (z) extent a(x) where a(x) is a periodic function with period d, referred to as the amplitude of the grating 2. In this example, the grating is periodic along one lateral (x) direction only but in general may vary in both the x and y directions or, for a 3-dimensional grating, in all three of x, y and z.

The grating 2 is generally trapezoidal in shape in this example; that is, the grating 2 appears as a series of repeating trapezoids 3 when viewed side-on (in general such a grating can be arbitrarily shaped provided the periodicity of its structure is maintained). The trapezoids are skewed by an angle α as measured between the z-axis and their medians. The trapezoids have left and right walls which are slanted by angles β1, β2 (which may or may not be the same) as measured relative to their medians. The trapezoids have a width w at their bases (linewidth), and a maximal vertical extent h=max a(x) (height) as measured in the z-direction 2.

In FIG. 1 the incident wave IW is shown an incident on the grating 2 from above (in the N1 or “superstrate” region), but a wave could also be incident on the grating 2 from below (in the N2 or “substrate” region).

The incident wave IW interacts with the grating 2, which causes diffraction of the incident wave IW to create multiple diffracted waves. These can include reflective mode waves, generally denoted RW, and transmission mode waves, generally denoted TW. By way of example, FIG. 1 shows three reflective mode waves and three transmissive mode waves: a zero order reflective mode wave RW(0), two first order (±1) reflective mode wave RW(+1), RW(−1), a zero order transmissive mode wave TW(0), and two first order (±1) transmissive mode waves TW(+1), TW(−1). There are theoretically an infinite number of reflected waves RW(−∞), . . . , RW(0), . . . , RW(+∞); and transmitted waves TW(−∞), . . . , TW(0), . . . , TW(+∞) though depending on the physical properties of both the incident wave IW and the grating 2, some of the diffracted waves may have negligible intensity or not be propagating waves at all.

The incident wave IW has a wave vector and an electric field, denoted k_{I}, E_{I}, as do each of the diffracted waves, for which the notation k_{D,m}, E_{D,m} is used (D=R for reflective mode waves and D=T for transmissive mode waves, and m being the order of the diffraction mode). A plane of incidence is defined as the plane in which both the incident wave vector k_{I} and the normal to the surface on which it is incident (which is parallel to the z-axis in FIG. 1) lie, which is the plane of the page in FIG. 1.

There are a number of scenarios in which it is desirable to predict the manner in which a wave will be diffracted from a grating. In particular, there are a number of scenarios in which it is desirable to predict the electric field(s) of one or more waves created by diffraction of that wave e.g. to predict their intensities(s) and/or polarization(s). For example, in the field of optical component design, an optical component designer will almost certainly want to know whether and to what extent a particular configuration of grating is going to function as desired before actually manufacturing a real-world grating with that configuration.

For a grating with only x-direction periodicity, the wave vectors k_{D,m} of the diffracted mode waves follow from the known grating equations (which can themselves be derived from Maxwell's equations):

$$\begin{matrix}N ( D ) * {k}_{y , D , m} = N ( I ) * {k}_{y , I} & ( 1 ) \\ N ( D ) * {k}_{x , D , m} = N ( I ) * {k}_{x , I} + Km \\ N ( W ) = \{ \begin{matrix}\begin{matrix}n 1 & for superstrate waves W \\ n 2 & for substrate waves W\end{matrix} , & K = \frac{2 π}{d} .\end{matrix} & ( 2 )\end{matrix}$$

In the above, x and y subscripts denote x and y vector components respectively, and m∈ [symbol] is the order of the diffraction mode ( [symbol] denoting the set of natural numbers). For gratings exhibiting more than one degree of periodicity, similar relationships can be derived enabling computationally efficient derivation of the diffracted wave vectors.

FIG. 1A shows the grating 2 in a more general diffraction scenario, in which a set of multiple plane waves IW(−∞), . . . , IW(0), . . . , IW(+∞) in the same plane of incidence are incident on the grating 2. So that they can be more readily distinguished, incident waves are represented by thinner arrows than diffracted waves. Each of the incident waves IW(m) has a respective propagation vector k_{I,m}, as satisfies the following relationships:

k_{x,I,m+1}=k_{x,I,m}+Km,k_{y,I,m+1}=k_{y,I,m} (3)

Each incident wave IW(m) diffracts at the grating 2 to create a respective infinite set of diffracted waves with propagation vectors given by equations (1) and (2). However, as will be evident, the aforementioned relationship between the propagation vectors k_{I,m} of the incident waves means that every set of diffracted waves will be exactly aligned with every other set of diffracted waves in direction. That is, the reflected wave RW(0) (resp. transmitted wave TW(0)) is a superposition of a zero order reflective (resp. transmitted) diffraction mode created by diffraction of IW(0), a −1 order reflective (resp. transmissive) diffraction mode by diffraction of RW(+1), a +1 order reflective (resp. transmissive) diffraction mode by IW(−1) etc. Similarly, the reflected (resp. transmitted) wave RW(−1) is a superposition of a zero order reflective (resp. transmissive) diffraction mode created by diffraction of IW(+1), a +1 order reflective (resp. transmissive) diffraction mode by diffraction of IW(0) and so on. Though not shown explicitly in FIG. 1A, each incident wave IW(m) has a respective electric and magnetic field component E_{I,m}, H_{I,m}. Each diffracted wave RW(m), TW(m) has a respective electric and magnetic field component E_{D,m}, H_{D,m}. (D=R, T) which is a superposition of the electric and magnetic field component of its constituent diffracted waves.

In many cases of practical interest, only one of the incident waves IW(−∞), . . . , IW(0), . . . , IW(+∞) will have a non-zero amplitude—as will be apparent, with this simplification the scenario of FIG. 1A reduces to that of FIG. 1. However, formulating the diffraction scenario in this manner is useful for reasons that will be apparent in view of the following. Note, the labelling of FIG. 1A is to some extent arbitrary e.g. any incident wave can be chosen as the “0” incident wave.

Predicting one or more of the electric fields E_{D,m} typically requires solving Maxwell's equations for a suitable set of boundary conditions that describe a diffraction scenario such as that of FIG. 1 i.e. that capture the physical properties of the incident wave IW, as well as the physical properties of the grating 2 (for which the notation G is used herein). In this manner, is possible to predict the electric fields E_{D,m} of the diffracted waves to an high level of accuracy. Once the electric fields E_{D,m} have been computed, the predicted polarization(s) and intensity(ies) of the diffracted wave(s) RW/TW follow, giving the optical component designer an accurate insight as to the effect a real-world grating with those physical properties G will have on such an incident wave IW.

However, as the structure of the grating becomes more complex, so too do the boundary conditions and the necessary calculations become time consuming and computationally expensive. In practice, it will be desirable to model many different diffraction scenarios that are not conducive to simple calculation, which potentially necessitates many such time consuming and computationally expensive calculations.

Nevertheless, in the context of optical component design, it is not uncommon to encounter the same or similar diffraction scenarios over time. Therefore, time and resources can be saved by, each time Maxwell's equations are solved for a particular scenario, saving the results for future use in case that scenario, or at least a sufficiently similar scenario for which those results can be reused, is (re)encountered in the future.

One way to do this would be to, having solved Maxwell's equations for a wave having particular values of electric field E_{I}, wave vector k_{I} and incident on a grating having physical properties G to predict the electric field vectors E_{D,m} of the resulting diffracted wave(s), store those predicted electric field vector(s) e.g. in a record of a database, the record labelled by a set of parameters which define the values of k_{I}, E_{I}, G. That way, to determine how a wave having those values of electric field E₁, wave vector k_{I} and incident on a grating having physical properties G would be diffracted, the previously determined diffracted electric field(s) in the database could be provided in the database, eliminating the need to re-solve Maxwell's equations for that combination.

Of course, using this approach, every time a new combination of k_{I}, E_{I}, G are encountered, Maxwell's equations would need to be solved for the new values even if the combination differs from some old combination of k_{I}, E_{I}, G (i.e. for which Maxwell's equations had already been solved) in just one aspect of one of k_{I}, E_{I} or G.

Moreover, in order to ascertain whether or not a solution to Maxwell's equations had already been computed in the past for some target values of k_{I}, E_{I}, G, it would be necessary to search the database for a label matching the target values. Each label in the database would typically need at least three parameters to describe k_{I} (e.g. polar and azimuthal angles, and wavelength λ), six to describe E_{I} (as it is a complex 3-vector), and at least one (but usually more in practice) to describe the physical properties G of the grating. The number of parameters needed to represent G depends on the assumptions being made about the grating in solving Maxwell's equations. As will be apparent, having to search this many parameters for matching values will become increasingly time-consuming as the size of the database grows.

In practice, such an approach would be very difficult: the probability of the database actually containing a reusable result only becomes non-negligible when the database has grown to a significant size; however, were the database to be built up using the above approach, before it could actually reach this size, searching is liable to become so slow that searching for a particular set of past results would potentially take as long as actually calculating that set of results from scratch using Maxwell's equations.

However, the inventors have recognized that such an approach would be unnecessarily restrictive, and that it is in fact there is a wider scope for reusing the results of past calculations in a manner that is viable. As explained below, using the inventors' approach, not only does the probability of the database actually containing a reusable result become non-negligible much sooner (as each individual result held in the database can be reused more often)—effectively reducing the required size of the database—but it also significantly reduces the number of parameters that need to be searched when looking for the results of past calculations, resulting in notable decreases in database search times. A search time reduction is also achieved by ordering the database in a specific manner, for which a search algorithm used to search the database is optimized. New records are added in a manner that maintains this ordering thereby retaining optimal conditions for the search algorithm as the database grows.

The combined effect of i) the database ordering and ii) the reduction in the number of parameters that need to be searched is enough to ensure that, when the database reaches a size at which it actually contains a useful number of results, searching the database for a past set of results is still significantly faster than solving Maxwell's equations to obtain that set of results from scratch, thereby enabling a practicable tool to be built up over time.

There are several methods that can be used to solve the Maxwell equations and the boundary problem. Some of the methods are based on Fourier expansion of all the periodic entities, such as electric and magnetic fields and the permittivity. These methods are called “Fourier Modal Methods” (FMM)—see “Diffraction analysis of dielectric surface-relief gratings”, M. G. Moharam and T. K. Gaylord; Vol. 72, No. 10, Optics Society of America (October 1982). A similar method is the so-called “C-method”. Whilst the handling of the problem is different for the C-method, the C-method also turns the problem into to an algebraic one. The C-method is described in “Rigorous and efficient grating-analysis method made easy for optical engineers”, Li et. al.; Vol. 48, No. 2, Applied Optics (January 1999).

The problem is thus turned to an algebraic one, where the task is to solve eigenvalue equations and the boundary problem using matrices. The matrices are theoretically infinite, but in practical calculations they are truncated to a finite size.

The fields are theoretically infinite vectors represented by the Fourier components, but in practical calculations the size of the matrices and vectors must be truncated (size N). Solving the diffraction problem then finally ends up with multiplication of the incoming field(s) with matrices that are the result of the calculations. A general field can be described with a linear combination of two orthogonal field components. The coefficients of the linear combination are generally complex numbers to describe any type of the field, i.e. linear, circular or elliptic polarizations. Thus there are 2N Fourier components that describe any field. So for the incoming field one can create a vector of 2N complex components, from where the number of non-zero components in most problem settings is only two. The solution of the diffraction problem brings up a 2N*2N matrix that contains everything to calculate the diffracted fields by matrix multiplication by the incoming 2N vector only. We can call these 2N*2N matrices scattering matrices. There is one matrix for the reflected fields (R-matrix) and one matrix for the transmitted fields (T-matrix). So it is enough to calculate once the diffraction problem and store the R and T matrices and the one can calculate the diffraction for any incoming field, i.e. for any incoming polarization. One needs not to store a large number of solved diffraction problems corresponding to a number of incoming fields in a diffraction data base. It is enough just to have one. A grating specification means thus a description of the groove profile, materials and the incoming field k-vectors, but not the polarizations.

For a given grating setup one needs to store only the 2N*2N matrices which are linked to the list of parameters that describe the problem. If the interest is only in the propagating orders of diffraction, the Matrices contain only a fraction of non-zero components of the total 4N² components, minimizing thus the need for the size of the data storage and makes the calculations much faster. A given grating problem can be described with a set of parameters (“diffraction parameter set”), such as period, wavelength, incoming k-vector, grating depth and parameters that describe the shape of the groove—but not electric or magnetic fields. This set is then liked to the non-zero matrix components that were obtained from the diffraction calculations and can be used again for a similar grating problem. It is also possible to use interpolations between already calculated setup as approximations, if needed (further details below).

An electromagnetic wave can be decomposed into a Transverse Electric (TM) polarization mode, i.e. a wave having an electric field component perpendicular to and a magnetic field component parallel to the plane of incidence, and a TM polarization mode, i.e. a wave having an electric field component parallel to and a magnetic field component perpendicular to the plane of incidence. For a problem that is invariant in the y-direction as it is shown in the figures, the so-called TE-TM decomposition applies, whereby the TE modes of the incident and diffracted waves are entirely decoupled from the TM modes due to the vanishing of the y-derivatives in Maxwell's equations. That is, the field components of TE (resp. TM) polarizations of the diffracted waves can be calculated from just the field components of the TE (resp. TM) polarizations of the incident wave(s) as they have no dependence on the TM (resp. TE) polarizations. Once calculated independently for a particular diffracted wave, the TE and TM components in combination give the overall electric field for that wave i.e. both its magnitude and polarization.

In FMM the 2N Fourier components can be defined as followed. An incoming vector is decomposed into two parts, one being a TE electric field component and the other one being a TM electric field component. A (reflective) scattering matrix

$$R = ( \begin{matrix}{R}^{11} & {R}^{12} \\ {R}^{21} & {R}^{22}\end{matrix} )$$

for the reflected waves RW(−∞), . . . , RW(0), . . . , RW(+∞) shown in FIG. 1A can be defined as follows:

$$( \begin{matrix}{E}_{R}^{TE} \\ {E}_{R}^{TM}\end{matrix} ) = ( \begin{matrix}{R}^{11} & {R}^{12} \\ {R}^{21} & {R}^{22}\end{matrix} ) ( \begin{matrix}{E}_{I}^{TE} \\ {E}_{I}^{TM}\end{matrix} ) \qquad ( 4 )$$

That is, the q^{th} reflective diffractive mode E_{R(q)}^{TE} is given by:

$$\begin{matrix}{E}_{R , q}^{TE} = {\sum }_{j} ( {R}_{qj}^{11} {E}_{I , j}^{TE} + {R}_{qj}^{12} {E}_{I , j )}^{TE} ) & ( {4}^{′} ) \\ {E}_{R , q}^{TM} = {\sum }_{j} ( {R}_{qj}^{21} {E}_{I , j}^{TE} + {R}_{qj}^{22} {E}_{I , j )}^{TE} ) & ( {4}^{″} )\end{matrix}$$

in which E_{I,j}^{TE} and E_{I,j}^{TM} mean the electric field of the j^{th} incident wave IW(j) (see FIG. 1A) for the TE and TM modes respectively, and E_{R,q}^{TE}, E_{R,q}^{TM} mean the electric field of the q^{th} reflected wave (see FIG. 1A) for the TE and TM modes respectively. The vectors in equation (4), and thus the scattering matrix R, are theoretically infinite. However, the vectors can be truncated to size 2N so as to contain N TE and N TM components, for instance TE and TM components for RW(−[N−1]/2), . . . , RW(0), . . . , RW([N−1]/2) if symmetry is desired, reducing R to size 2N*2N accordingly, A (transmissive) scattering matrix

$$T = ( \begin{matrix}{T}^{11} & {T}^{12} \\ {T}^{21} & {T}^{22}\end{matrix} )$$

for the reflected waves TW(−∞), . . . , TW(0), . . . , TW(+∞) shown in FIG. 1A can be defined in the same manner.

In C-method the 2N components are electric and magnetic fields. A (reflective) scattering can be similarly defined, however in this case it is convenient to define it in terms of both the E and H field as follows:

$$( \begin{matrix}{E}_{R}^{TE} \\ {H}_{R}^{TM}\end{matrix} ) = ( \begin{matrix}{R}^{11} & {R}^{12} \\ {R}^{21} & {R}^{22}\end{matrix} ) ( \begin{matrix}{E}_{I}^{TE} \\ {H}_{I}^{TM}\end{matrix} ) \qquad ( 5 )$$

in which E_{R}^{TE}=( . . . , E_{R,q}^{TE}, E_{R,q+1}^{TE}, . . . ) and H_{R}^{TM}=( . . . , H_{R,q}^{TM}, H_{R,q+1}^{TM}, . . . ), E_{R,q}^{TE} and H_{R,q}^{TM} being the electric field for the TE mode and the magnetic field for the TM mode respectively. The magnetic field can be represented as a linear combination of electric field components according to Maxwell equations. Thus, once calculated, the electric field of the TM mode can be easily computed from H_{R}^{TM} from Maxwell's equations, using the relationship

$$H = \frac{n}{z} \hat{k} \times E ,$$

in which \hat{k} is the direction of propagation (unit vector) and Z=\sqrt{μ₀/∈₀} is the vacuum impedance. Again, the vectors in equation (4) are infinite but can be truncated to size 2N to contain N E-field and N H-field components, e.g. for RW(−[N−1]/2), . . . , RW(0), . . . , RW([N−1]/2). Again, a transmissive scattering matrix can be defined and truncated in the same way.

In a practical scenario of interest, often only the j^{th} components of incoming fields are non-zero i.e. only the j^{th} incident wave IW(j) has non zero field amplitudes (j can be any integer within the truncation limits).

Importantly, whilst R and T as defined in equations (3) or (4) above depend on the incident wave vectors, fully defined by k_{I,0} which incorporates both wavelength λ and propagation direction, and the physical properties G of the grating 2, they have no dependence on the electric or magnetic fields of the incident waves. Thus, for any given k_{I,0}, G, the desired scattering matrix(es) need only be calculated once, and can thereafter be used for any values of the electric or magnetic fields provided k_{I,0}, G are the same.

When a propagating incident plane wave is diffracted by a grating, this can, in addition to diffracted propagating waves, give rise to non-propagating, evanescent waves i.e. fields whose amplitudes decay exponentially as a function of distance from the grating without transferring energy to the medium in which they are formed. In such cases, the full scattering matrix will describe both propagating and non-propagating diffraction modes i.e. some of the components of the scattering matrix correspond to propagating diffraction modes rather and the remaining components to non-propagating diffraction modes.

If the interest is only in the propagating orders of diffraction, only a fraction of the non-zero components of the total 4N² components (i.e. the propagating components) are needed, reducing the amount of the data storage needed and making the calculations much faster. There are 4 components for reflection and 4 components for transmission, per diffraction mode, that belong to one propagating order. Thus only 8N*P of the 4N² components of the scattering matrix correspond to propagating orders, where P is the number of propagating orders. Therefore usually only that many components need to be stored.

Note, below the simplified notation k_{I} is used in place of k_{I,0}.

A particular combination of k_{I}, E_{I}, G, can be parameterized by a collection of parameters p1, p2, . . . pM, some of which parameterize k_{I} and G, and the rest of which parameterize E_{I}. For example, two such parameters (such as a polar and an azimuthal angle) may represent the direction of k_{I}, one to represent the magnitude of k_{I} (∝λ_{I}) and at least one but typically more to represent G (e.g. with parameters which define the shape and configuration of the grating, such as its period d, slant α, wall angle(s) β1/β2, linewidth w, height or equivalently depth h, wall curvature and shape etc.); in addition, in general six parameters will be needed to represent the six components of the complex vector E_{I}.

The inventors have appreciated that, once Maxwell's equations have been solved for a particular a combination k_{I}, E_{I}, G and a scattering matrix S (equal to R or T as defined above) thereby determined, thereafter that scattering matrix S can be used to determine the values of the electric field(s) of the diffracted wave(s) created when any incident wave having any arbitrary electric field E′_{I}≠E_{I} is diffracted, provided that incident wave has the same wave vector k_{I} and is diffracted by a grating with the same physical properties G (the only inherent restriction being that E′_{I} is of course perpendicular to k_{I}). As will be apparent in view of the above, this amount in substance to a matrix multiplication of the relevant scattering matrix with the relevant incoming field vector, as defined by equation (4) or (5) above. In other words, whilst the scattering matrix is specific to that particular propagation direction and wavelength of the incidence wave (as captured in k_{I}) and that particular grating, it is independent of the electric field of the incident wave, and thus also independent of the magnetic field. Thus, the computed scattering matrix is specific to a sub collection q1, q2, . . . qL of that collection of parameters (L<M, where each of q1, q2, . . . qL corresponds to a respective one of p1, p2, . . . pM), where the sub collection q1, q2, . . . qL parameterizes the incident wave vector and the grating itself (but not the incident electric field), but is independent of the remaining M-L parameters which parameterize the incident electric field. Six parameters are needed to fully represent a (complex) electric field vector, which means the sub collection q1, q2, . . . qL is smaller than the full collection by up to six (i.e. M-L may be as high as 6).

Herein, the notation P={c, d, . . . } is used to denote a full set of parameter values p1=c, p2=d, . . . i.e. P specifies all three of k_{I}, E_{I} and G. The notation Q={a, b, . . . } is used to denote a selective set of parameter values q1=a, q2=b, . . . etc. which specifies k_{I} and G, but not E_{I}. Such restricted sets Q are examples of “diffraction parameter sets” as the term is used herein.

The notation S(Q) denotes the scattering matrix for the incident wave vector k_{I} and grating G as defined by the values in Q.

The number of parameters in Q (and thus in P) depends on the nature of the approximations made in solving Maxwell's equations i.e. on the number of variables permitted. When parameterizing the grating itself, a relatively crude assumption would be, for instance, that any grating is sinusoidal in shape, in which case just two parameters could be used to approximate physical parameters G of a grating: one to set the period of the sinusoidal variations (i.e. the grating period), and the other to set the height of those variations. A different, and in some senses more sophisticated assumption, might be to assume that any grating is trapezoidal in shape, but to allow the height h, width w, period d, and angles α, β1/β2 as shown in FIG. 1 to vary, in which case parameters would be needed to define all of these various properties. A yet more sophisticated assumption would be to, say, permit varying amounts of curvature in the shape of the grating, in which case one or more additional parameters would be needed to define the shape. When parameterizing k_{I}, generally three parameters are needed (two for direction and one for wavelength), but this could be reduced for instance by assuming e.g. that all waves are incident on the grating with k_{y,I}=0. In one of the most general cases, the grating could be represented in terms of the coefficients of a Fourier expansion of the periodic grating amplitude a(x) (generally, there will be an infinite number of such coefficients so truncation may be required).

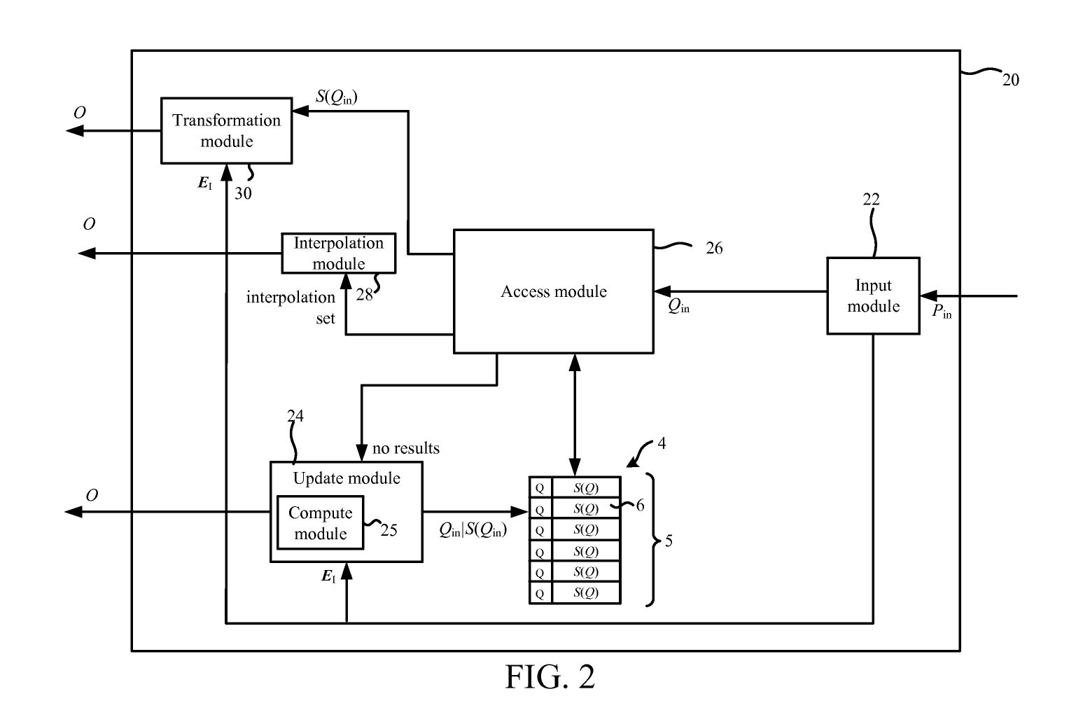

FIG. 2 is a function block diagram of a diffraction grating modelling system 20, which comprises a database 4, an input module 22, an update module 24 (which itself comprises a compute module 25), an access module 26, an interpolation module 28, and a transformation module 30. The various modules 22-30 of system 20 represent functionality implemented by executing respective code on a computer processor.

The input module 22 has an input which is also an input of the system 20. The access module 26 can access the database 4, and has a first output connected to an input of the interpolation module 28, a second output connected to a first input of the transformation module 30, a third output connected to a first input of the update module 24, and an input connected to a first output of the input module 22. The update module 24 has a second input connected to a second output of the input module 22 and an output which is a first output of the system 20. The transformation module 30 has a fourth input connected to the second output of the input module 2 and an output which is a second output of the system 20. The interpolation module 28 has an output, which is a third output of the system 20.

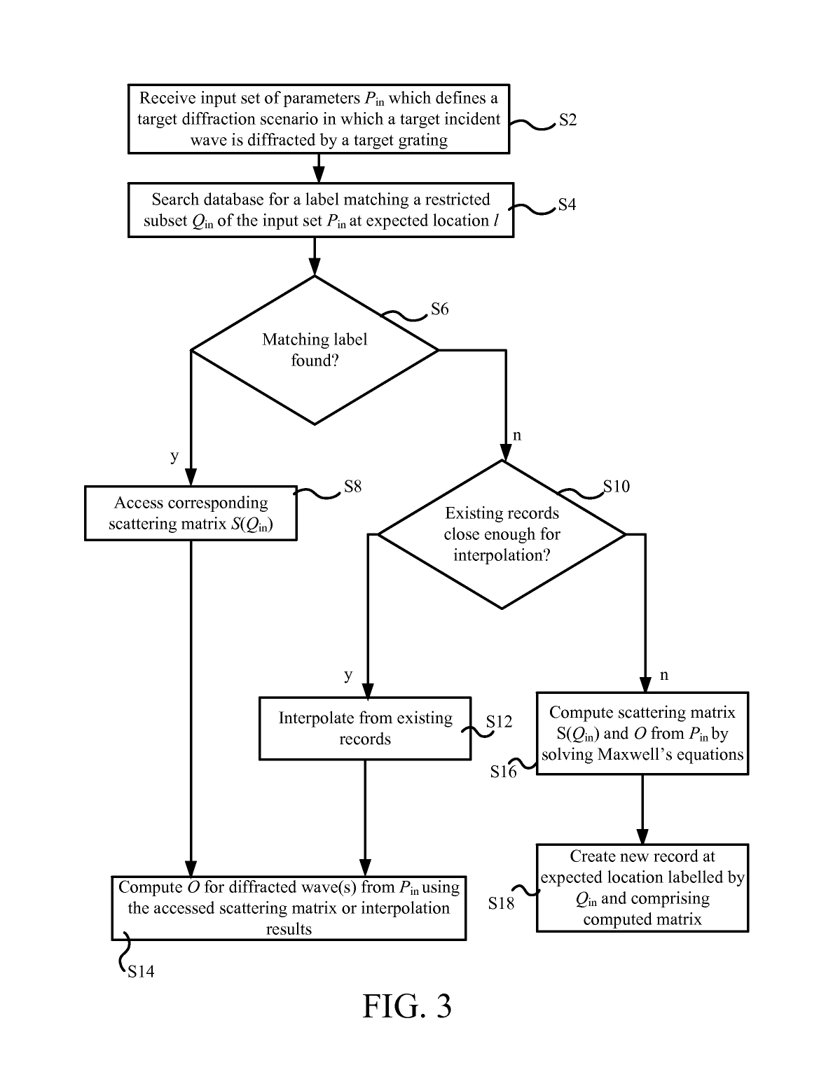

A method effected by the system 20 will now be described with reference to FIG. 3, which is a flow chart for the method.

At step S2, the input module 32 receives an input set of parameter values Pin which fully defines a target diffraction scenario i.e. which specifies a wave vector k_{I} and electric field E_{I} of a target electromagnetic plane wave, as well as the physical properties G of a target grating on which that wave is incident. The parameters in Pin may be defined by a user of the system 20 inputting information via a suitable user interface of the system 20.

As explained in more detail below, the system 20 (either the transformation module 30, interpolation module 28, or update module 24) determines from the input set Pin, in a computationally efficient manner, an output set of parameters O which define the wave electric field(s) E_{D,m} of a desired number of reflective and/or transmissive mode diffracted beams created by diffraction of the target wave by the target diffraction grating. For example, the set O might define the wave vectors and electric fields of the J lowest order reflective mode diffracted waves (i.e. D=R; m=−J, . . . , 0, . . . , J) and/or the N lowest order transmissive mode diffracted waves (i.e. D=T; m=−J, . . . , 0, . . . , J), thereby defining electric fields and wave vectors for 2(2N+1) diffracted waves in total. Here, J=[N−1]/2 where N is the truncation size defined above.

The compute module 25 is capable of solving Maxwell's equations for the set Pin to determine the parameters values O. The number of parameters used to parameterize k_{I}, E_{I}, G, and thus the number of values of Qin and Pin, depends on the assumptions that are built into the compute module 25 in determining O.

In this example, two parameters q1, q2 are used to define k_{I} and G so that Qin={a,b}, “a” being the value of q1 specified in Q1 and “b” being the value specified by q2. This could, for instance, correspond to a situation in which the only variables are, say, polar azimuthal angle and grating period, which are specified by a and b (with the remaining information about azimuthal angle of incidence, wavelength and grating configuration being specified by assumptions that are built into the compute module 25). This is a simplified example for the purposes illustration; in other examples, much larger numbers of parameters will be used.

As indicated, solving Maxwell's equations can involve lengthy and expensive computations. Such computations are avoided whenever possible. Specifically, when possible, O is instead determined sing a scattering matrix S(Qin) which has already been computed by solving Maxwell's equation at some point in the past so as to avoid the compute module 25 having to solve them again. Determining the diffracted field(s) from a scattering matrix is significantly more straightforward (and computationally cheap) than solving Maxwell's equations again, but nevertheless yields the same results provided the correct scattering matrix is used.

For this reason, the database 4 holds the results of such past calculations that can be accessed for this purpose. The database 4 comprises a sequence 5 of records 6. Each record 6 is labelled by a diffraction parameter set Q—which defines a particular incidence wave vector k_{I} and grating G (but not the incident electric field E_{I})—and comprises the corresponding scattering matrix S(Q) as computed at some point in the past for that Q (which is independent of E_{I}, which is the reason the labels do not need to include any information about E_{I}). The sequence 5 is ordered by diffraction parameter set Q.

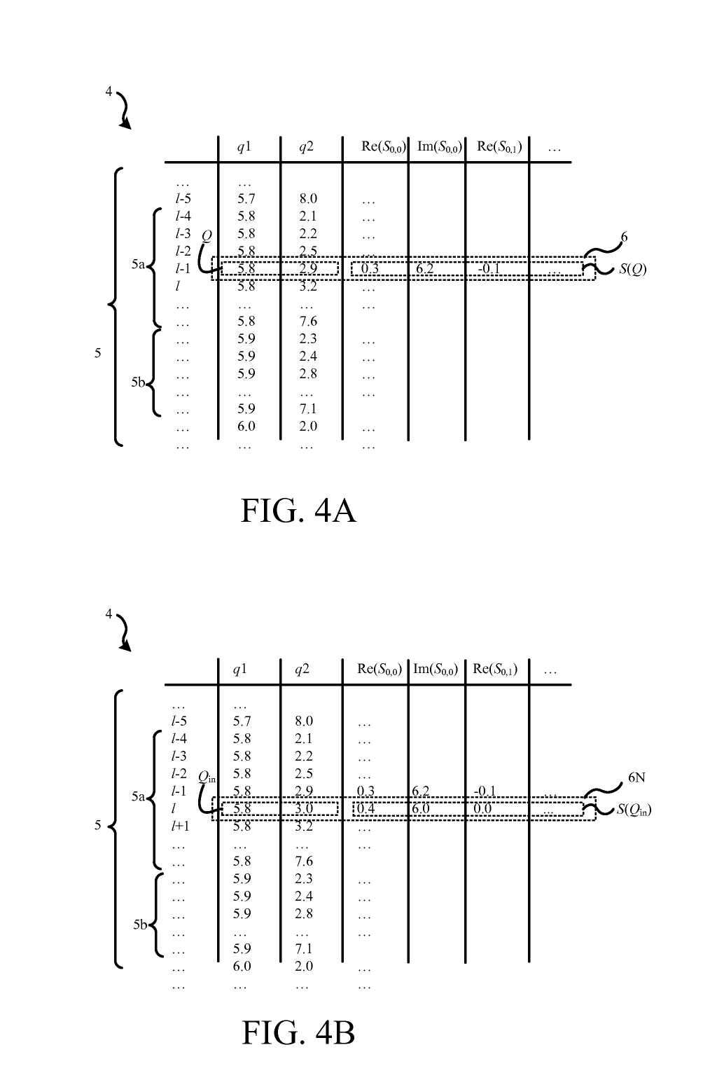

An exemplary form of the database 4 is shown in FIG. 4A. For each record, the two left-most entries constitute a diffraction parameter set Q (containing values of q1 and q2 respectively), and the remaining entries contain the various real and imaginary components (Re(S_{0,0}), Im(S_{0,0}), Re(S_{0,1}), . . . ) of the corresponding scattering matrix S(Q).

In this example, the sequence 5 is ordered by Q in that each record has a position ( . . . , l−2, l−1, l, . . . ) in the sequence 5, which is determined by its label. In the example of FIG. 4A, records are sorted primarily according to q1 so that all records labelled by the same value of q1 are grouped together to form an individual subsequence (e.g. 5a, 5b, which are subsequences of records with q1=5.8 and q1=5.9 respectively), with the subsequences arranged in increasing order of q1. Each subsequence is then sorted according to q2, so that within each subsequence records are arranged in increasing order of q2. Similar ordering can be imposed on a sequence of records labelled by more than two parameters, and other types of ordering will be apparent.

A restricted diffraction parameter set Qin, where Qin is a restricted subset of Pin, and defines k_{I} and G but not E_{I}, is extracted from Pin by the input module 22 and supplied to the access module 26. This Qin describes the target diffraction scenario defined by Pin, but does not fully define it in the way that Pin does because it omits field information.

At step S4, the access module 26 searches the database 4 for a record matching the input restricted subset Qin. The remaining M-L parameters in Pin (but not Qin) are not used in searching the database 4.

The database is searched at S4 according to a search algorithm which is optimized for sequences labelled and ordered by parameter set Q. That is, the search algorithm makes use of the fact that the database is structured in this manner in order to reduce the time it takes to search the database. Searching an ordered database is generally faster than searching a non-ordered one.

The purpose of the searching step S4 is two-fold. Primarily, the aim is to find a record that matches Qin i.e. a record whose label matches both the value “a” of q1 and the value “b” of q2 specified in Qin exactly or at least to within, say, a predetermined number of decimal points (which could be a tuneable parameter of the system). At step S6, if a matching record is found at an expected position in the sequence 5 i.e. with a label that matched Qin, the corresponding scattering matrix S(Qin) is simply accessed (S8) and supplied to the transformation module 30.

The expected position means the position in the sequence 5 at which the record would appear if present given the manner in which the sequence 5 is ordered e.g. using FIG. 4A as an example, if Qin={5.8, 3.0}, the expected position is position l i.e. after {5.8, 2.9} but before {5.8, 3.2}—however, because in the example of FIG. 4A there is no record matching Qin, the record labelled {5.8, 3.2} is present at location/instead.

Failing that, the aim is to find one or more near-matching records which can be used to determine an approximation of the diffracted field(s) to an acceptable level of accuracy. Returning to step S6, if no matching record is found, it is determined (S10) whether there are records in the database which satisfy an interpolation condition. The interpolation may for instance be that an expected error margin(s) on the interpolated results is below a threshold (or below respective thresholds where there are multiple error margins). If the interpolation condition is satisfied, then at step S12 the set of at least J records whose labels are within the specified thresholds (interpolation set) are accessed to retrieve the corresponding scattering matrices.

In some embodiments, the interpolation condition may for example be that there at least J records whose q1 labels are within ±Δq1 of “a” (i.e. the q1 value specified in Qin) and whose q2 labels are within ±Δq2 of “b” (i.e. the q2 value specified in Qin). In one embodiment, an approximation of the scattering matrix S(Qin) is computed by interpolation of the interpolation set and supplied to the transformation module 30. Each scattering matrix can be regarded as a multivariate function S(Q)=S(q1, q2) (i.e. a function of both q1 and q2 in this example). There are a number of known multivariate interpolation techniques that can be used to interpolate from the interpolation set an approximation of the scattering matrix S(Qᵢₙ)=S(q1=a, q2=b).

Here, Δq1 and Δq2 are predetermined interpolation thresholds, and J is an integer; Δq1 and Δq2 former set how nearby in Q-space a label has to be to Qin before use of the corresponding scattering matrix for interpolation is permitted, and J sets how many such records must be present to permit interpolation. Increasing Δq1, Δq2 and/or decreasing J will on the one hand mean that interpolation is permitted on more occasions, but will mean that, on average, the results of the interpolation are less accurate. The extent to which this is acceptable will depend on the context (in particular on the accuracy required for the output set O). In embodiment, Δq1, Δq2 and J can be tuneable parameters which a user of the system 20 can set depending on their needs.

This is merely exemplary—different interpolation methods are viable. For example, one or more near-matching records, i.e. those for which an interpolation condition is satisfied, could be used to calculate diffracted fields, and the calculated fields then interpolated to give the diffracted fields for the target scenario, for example using linear interpolation.

Where the input set indicates a target incident unit propagation vector \hat{k}_{I} (referred to as “the alpha-vector” and denoted \hat{α}₀ below) which does match a record(s) in the database, but one or more of the other target parameters (λᵢₙ, Gᵢₙ) do not match that record(s), the scattering matrix contained in the matching record(s) can be used to calculate diffracted field vector(s) using λ, G, and then linear interpolation can be used to transform the diffracted fields to those for (approximately) λᵢₙ, Gᵢₙ in a manner that will be readily apparent. That is, if a record label indicates a matching unit incident propagation vector, straightforward linear interpolation can be used to accommodate other non-matching but relatively nearby parameters.

Where a matching alpha-vector cannot be found, interpolation is still possible but is a little more involved.

A target alpha-vector \hat{α}₀ can be extrapolated to the nearest case in database in the following manner. A target incoming k-vector and incoming electric field are denoted \hat{α}₀ and E_{I} (written as \vec{E}₀ below). The closest alpha-vector in the database to the incoming one is denoted \hat{α}_{D}—this can be found from the database 4 by finding the maximum of the dot-product |\hat{α}₀·\hat{α}_{D}|. That is, for each record 6 the dot product of \hat{α}₀ with that record's unit alpha vector is found, and the record for which the dot-product is maximized (relative to any other record) is selected.

Once the closest \hat{α}_{D} is found, what would be the electric field \vec{E}_{D} corresponding to the \hat{α}_{D} vector is calculated. That is, a transformation is applied to target electric field \vec{E}₀, the result of which is \vec{E}_{D}. \vec{E}_{D} must satisfy the condition \hat{α}_{D}·\vec{E}_{D}=0, which in general will not be satisfied by \vec{E}₀. The method is such that the electric field is presented in linear combination of two base vectors, one of them being in the plane defined by vectors \hat{α}ᵢₙ, and \hat{α}_{D}. The normal of the plane is

$$\hat{n} = \frac{{\hat{α}}_{0} \times {\hat{α}}_{D}}{\vert {\hat{α}}_{0} \times {\hat{α}}_{D} \vert} .$$

A unit vector that is in the plane and is perpendicular to \hat{α}_{D} is

$$\hat{m} = \frac{{\hat{α}}_{D} \times \hat{n}}{\vert {\hat{α}}_{D} \times \hat{n} \vert} .$$

The vectors \hat{n} and \hat{m} can now be used as base vectors for the incoming electric field. The field that is used in calculation is then

\vec{E}_{D}=(\vec{E}₀·\hat{n})\hat{n}+(\vec{E}₀·\hat{m})\hat{m} (“diffracted electric field vector”)

Using the database the k-vectors and electric fields of the diffracted light can now calculated. These are denoted \hat{α}_{D,q} and \vec{E}_{D,q} which represent all the diffracted propagating fields, reflected (D=R) and transmitted (D=T). The diffracted k-vectors \hat{α}_{D,q} and diffracted fields \vec{E}_{D,q}, calculated from the database 4, are not the same as calculated the “real” diffracted k-vectors and diffracted fields for the actual target scenario (i.e. as defined by \hat{α}₀ and \vec{E}₀). The real diffracted k-vectors and diffracted fields are denoted \hat{α}_{0,q} and \vec{E}_{0,q}. The same field calculation procedure is made as was made for the incoming field, but reverses. Unit vectors representing base vectors for each mode q are defined as:

$${\hat{n}}_{q} = \frac{{\hat{α}}_{0 , q} \times {\hat{α}}_{D , q}}{\vert {\hat{α}}_{0 , q} \times {\hat{α}}_{D , q} \vert}$$

$$and$$

$${\hat{m}}_{q} = \frac{{\hat{α}}_{0 , q} \times {\hat{n}}_{q}}{\vert {\hat{α}}_{0 , q} \times {\hat{n}}_{q} \vert} .$$

The Electric fields \vec{E}_{D,q} calculated from the database values can now be converted to the fields representing the real diffraction from of the incoming field \vec{E}₀

\vec{E}_{0,q}=(\vec{E}_{D,q}·\hat{n}_{q})\hat{n}_{q}+(\vec{E}_{D,q}·\hat{m}_{q})\hat{m}_{q}).

A small error remains in the intensities of the beams, but if the k-vectors \hat{α}₀ and \hat{α}_{D} are close enough the error is negligible. It is also possible to make a small correction to correct this error, if needed.

The above-described alpha-vector interpolation can be combined with linear interpolation of other parameters straightforwardly.

An input unit vector may not be indicated directly (though that is not excluded)—for instance, a non-unit wave vector k indicates the corresponding unit propagation vector \hat{k} as the latter can be determined by normalizing the former. Similarly, a field may be indicated directly or indirectly (e.g. the electric field of a wave indirectly indicates the wave's magnetic field as a consequence of Maxwell's equations, and vice versa).

Step S14 is performed in the even that either a matching record is found at S8 or an interpolation is determined to be possible at step S10. At Step S14, the set of parameters O representing the diffracted electric fields E_{D,m} is computed by the transformation module 30 or interpolation module 28 as applicable from the incident electric field vector E_{I} indicated full set Pin using the either the accessed scattering matrix (of step S8) or the results of the interpolation (of step S12) e.g. the interpolated scattering matrix. This is a quick and computationally inexpensive operation. The set O as computed at S14 is then outputted as an output of the system 20 e.g. to a user of the system 20 via a suitable user interface, for example displayed in a user friendly (e.g. graphical) format on a display. The set Pin may also be received vie the user interface at step S2.

Returning to step S10, if the interpolation condition is not satisfied, then at step S16 the access module 26 conveys the lack of results to the update module 24. In response, the compute module 25 of the access module 24 computes the set of parameters O representing the diffracted electric fields E_{D,m} from the full input set Pin by solving Maxwell's equations for a suitable set of boundary conditions defined by Pin. This is a time consuming an computationally expensive operation, but one which is performed only when no record matching Qin can be found in the database, and even in that even only when interpolation from non-matching by nearby records i.e. one which is performed only as a last resort. The scattering matrix S(Qin) is also computed as part of that operation. The set O as computed at step S16 is then outputted as an output of the system 20 in the same way as if it has been calculated at step S14, e.g. via the user interface.

The compute module 25 can be configured to implement various numerical methods for solving Maxwell's equations.

At step S18, the scattering matrix as computed at step S16 is stored in the database for future use. To this end, a new record labelled by Qin and comprising the newly-computed matrix S(Qin) is created in the database. The new record is created at the expected position in the sequence 5 i.e. at a position such that the sequence 5 remains ordered by Q even with the addition of this new record. This is illustrated in FIG. 4B, in which such a new record 6N is illustrated, having been inserted at position l (the expected position in this example), thereby shifting the records previously at positions ≧l along in the sequence 5 by one.

As the method is repeated over time, the database 4 is built up with more and more results in the form of scattering matrices, thus becoming an increasing useful tool. As it is built up, the ordering of the sequence 5 is maintained i.e. the sequence remains ordered by Q which means the database remains tractable as it grows. Moreover, efficiency of searching is maintained as it is this ordering for which the search algorithm is optimized.

No electric field information has to be searched at step S4. This reduces the overall time it takes to complete S4 significantly, as is electric field information did have to be searched, this would generally require six additional fields (corresponding to the six components of the complex 3-vector) to be searched. The resulting search time reductions are especially significant as the database becomes very large.

Any of the modelling methods, systems or software disclosed herein can be incorporated in a grating manufacturing process i.e. used to manufacture a physical, real-world diffraction grating. For example, a grating with certain physical properties can be manufactured where modelling has revealed that those physical properties would be desirable for a particular application.

As mentioned above, a scattering matrix may contain both propagating components, which correspond to diffracted electromagnetic fields that propagate as waves, but also effervescent components, which correspond to rapidly decaying electromagnetic fields also created by diffraction of the incident wave. In some contexts, the latter are of no interest to the user of the system 20 (who may for example be an optical component designer). Thus, at step S18, only the propagating components of the computed scattering matrix may be stored. This significantly reduces the size of each record in the database without reducing its usefulness. The consequent memory saving is particularly significant as the database grows to be very large. However, the possibility of keeping some or all of the non-propagating components is not excluded as occasionally they may be useful.

The term “scattering map” is used herein to mean any representation of an electric field transformation such as that induced by a diffraction grating diffracting an incident wave. Both scattering matrices and selective components thereof (e.g. which includes but is not limited to only the propagating components thereof) constitute scattering maps. The nature of such an electric field transformation means that the scattering map will be independent of the incident electric field and, once calculated for a particular combination of k_{I}, E_{I}, G, can be used to straightforwardly determine one or more diffracted electric fields for any combination k_{I}, E′_{I}≠E_{I}, G. Because of this, any database of scattering maps is such that no searching of electric field information is required when attempting to retrieve a scattering map applicable to a current target scenario.

Whilst in the above, diffracted electric fields are calculated, diffracted magnetic fields could be computed alternatively or in addition according to the same principles.

The term database is used herein to mean any ordered collection of data (which includes both physical and/or logical ordering—the latter being defined, for instance, by associated metadata) held in computer storage, and does not imply any particular type of data structuring. In the simplest cases, a database may simply be embodied as a text file, spreadsheet file etc.

The information in the sets P/Pin and Q/Qin can be parameterized in any desired manner e.g. the values which defines wavelengths of electromagnetic waves do not necessarily have to be wavelengths per se, but could be e.g. spatial frequencies, temporal frequencies or periods (as these have a known relationship to one another) etc.

Note the term “set” is not used herein in the strict mathematical sense, but generally covers any collection of values in whatever manner they may be represented.

Whilst the above considers a software implementation of the diffraction grating modelling system 20, generally, any of the functions described herein can be implemented using software, firmware, hardware (e.g., fixed logic circuitry), or a combination of these implementations. The terms “module,” “functionality,” “component” and “logic” as used herein can generally be implemented as software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, a computer device may also include an entity (e.g. software) that causes hardware of the computer device to perform operations, e.g., processors functional blocks, and so on. For example, the computer device may include a computer-readable medium that may be configured to maintain instructions that cause the computer device, and more particularly the operating system and associated hardware of the computer device to perform operations. Thus, the instructions function to configure the operating system and associated hardware to perform the operations and in this way result in transformation of the operating system and associated hardware to perform functions. The instructions may be provided by the computer-readable medium to the computer device through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

In embodiments of the various aspects set out in the Summary section, the scattering maps may not include any information about non-propagating diffraction modes.

The system of the first aspect may comprise a transformation module configured to use the accessed scattering map to compute a field of a diffracted wave created in the target scenario. For example, the system may comprise an input configured to receive an indication of a target incident field vector, the field of the diffracted wave being computed from the target incident field vector and the access scattering map.

The access module may be configured, when no matching record is found, to determine whether there exists in the database a set of one or more records that satisfies an interpolation condition, and the update module may compute the scattering map from the input set only when (i) no matching record is found and (ii) no such set of records exists. For example, the system may comprise an input configured to receive an indication of a target incident field vector, and an interpolation module configured, if such a set of records does exits, to interpolate from the set and the incident target field vector, a field of a diffracted wave that would be created in the target scenario.

In one such embodiment, each record's diffraction parameter set may indicate an incident unit propagation vector, and the input diffraction parameter set indicates a target incident unit propagation vector, and the interpolation module may be configured to perform the following steps:
identify a record for which the vector dot product between that record's incident unit propagation vector and the target incident unit propagation vector is maximized;
apply a transformation to the target field vector to generate a transformed electric field vector that is perpendicular to the identified record's incident unit propagation vector;
apply the identified record's scattering map to the transformed field vector to compute an intermediate diffracted field vector; and
apply an inverse of the transformation to the intermediate diffracted field vector to compute the field of the diffracted wave.

The interpolation module may be configured to use linear interpolation.

The interpolation module may be configured to compute an interpolated scattering map from the set of records and use the interpolated scattering map to compute the field of the diffracted wave.

The diffraction parameter sets may not include any values which represent electric or magnetic fields.

Each diffraction parameter sets may comprise at least one value which defines a property of an incident wave and/or at least one value which defines a property of a diffraction grating.

Each diffraction parameter sets may comprise a value which defines the wavelength of the incident wave and/or a value which defines an angle of incidence of the incident wave. For example, each diffraction parameters set may comprise two values which define the propagation direction of the incident wave in three dimensional space.

The diffraction parameter set may comprise:
a value which defines a period of the grating; and/or
a value which defines a slant angle of the grating; and/or
a value which defines a wall angle of the grating; and/or
a value which defines a height of the grating; and/or
a value which defines a linewidth of the grating; and/or
a value which defines the shape of the grating.

The system may have a user interface via which the input set is received and/or via which the field of the diffracted wave is outputted.

In another aspect, disclosed is a computer readable storage medium storing code for use with a database, the database comprising a sequence of records, each labelled by a diffraction parameter set which describes a diffraction scenario and comprising a corresponding scattering map which describes a field transformation induced in that scenario, wherein the sequence is ordered by diffraction parameter set, the code configured when executed to cause operations which comprise: receiving an input diffraction parameter set which defines a target diffraction scenario; searching the database for a record matching the input set at an expected position in the sequence and accessing the corresponding scattering map when found; and only when no matching record is found, computing from the input set a scattering map for the target scenario, and creating a new record in the sequence which is labelled by the input set and comprises the computed map, the new record created at the expected position, whereby the sequence remains ordered by parameter with the addition of the new record.

In a fourth aspect, a diffraction grating modelling system comprises:

a memory configured to store a database, the database comprising:

a sequence of records, each one of the sequence of records labelled by a diffraction parameter set that describes a diffraction scenario; and

a scattering map that describes a field transformation induced in that scenario, wherein the sequence is ordered by diffraction parameter set;

a processor in communication with the memory, the processor configured to:

receive an input diffraction parameter set which defines a target diffraction scenario;

search the database for a record matching the input set at an expected position in the sequence, and to access the corresponding scattering map when found; and

when no matching record is found, compute from the input set a scattering map for the target scenario, and to create a new record in the sequence which is labelled by the input set and comprises the computed map, the new record created at the expected position, wherein the sequence remains ordered by parameter set with the addition of the new record.

In a fifth aspect, a diffraction grating modelling system comprises:

a memory configured to store a database, the database comprising:

a sequence of records, each one of the sequence of records labelled by a diffraction parameter set that describes a diffraction scenario in which an incident wave is diffracted; and

a scattering map that describes a field transformation induced in that scenario, wherein the diffraction parameter sets set do not specify any fields of the incident waves; a processor in communication with the memory, the processor configured to:

receive (i) an input diffraction parameter set which defines a target diffraction scenario in which a target incident wave is diffracted and (ii) input field data which specifies a field of the target incident wave;

search the database using the input set but not the input field data for a record matching the input set, and to access the corresponding scattering map when found; and

use the accessed scattering map to compute from the input field data a field of a diffracted wave created in the target scenario.

In embodiments, the processor of the fourth or fifth aspect may any additional functionality of the various functional modules described herein.

In a sixth aspect, a method comprises:

receiving an input diffraction parameter set which defines a target diffraction scenario, the input diffraction parameter set indicating a target incident unit propagation vector;

receiving an indication of a target incident field vector for the target scenario;

accessing a database comprising a plurality of records, each labelled by a diffraction parameter set which describes a diffraction scenario and comprising a corresponding scattering map which describes a field transformation induced in that scenario, wherein the diffraction parameter set indicates an incident unit propagation vector;

identifying a record for which the vector dot product between that record's incident unit propagation vector and the target incident unit propagation vector is maximized;

applying a transformation to the target incident field vector to compute a transformed vector that is perpendicular to the identified record's incident unit propagation vector;

applying the identified record's scattering map to the transformed electric field vector to compute an intermediate diffracted field vector; and

applying an inverse of the transformation to the intermediate diffracted field vector to compute a diffracted field vector of a diffracted wave that would be created in the target scenario.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A diffraction grating modelling system comprising:
a memory configured to store a database, the database comprising:
a sequence of records, each one of the sequence of records labelled by a diffraction parameter set that describes a diffraction scenario; and
a scattering map that describes a field transformation induced in that scenario, wherein the sequence is ordered by diffraction parameter set;
a processor in communication with the memory, the processor configured to:
receive an input diffraction parameter set which defines a target diffraction scenario;
search the database for a record matching the input set at an expected position in the sequence, and to access the corresponding scattering map when found; and
when no matching record is found, compute from the input set a scattering map for the target scenario, and to create a new record in the sequence which is labelled by the input set and comprises the computed map, the new record created at the expected position, wherein the sequence remains ordered by parameter set with the addition of the new record.

2. A system according to claim 1 wherein the scattering maps do not include any information about non-propagating diffraction modes.

3. A system according to claim 1 wherein the processor is further configured to use the accessed scattering map to compute a field of a diffracted wave created in the target scenario.

4. A system according to claim 3 wherein the processor is further configured to receive an indication of a target incident field vector, the field of the diffracted wave being computed from the target incident field vector and the access scattering map.

5. A system according to claim 1 wherein processor is further configured, when no matching record is found, to determine whether there exists in the database a set of one or more records that satisfies an interpolation condition, wherein the processor is further configured to compute the scattering map from the input set only when (i) no matching record is found and (ii) no such set of records exists.

6. A system according to claim 5 wherein the processor is further configured to receive an indication of a target incident field vector, and, if such a set of records does exits, to interpolate from the set and the incident target field vector, a field of a diffracted wave that would be created in the target scenario.

7. A system according to claim 6 wherein each record's diffraction parameter set indicates an incident unit propagation vector, and the input diffraction parameter set indicates a target incident unit propagation vector, wherein the processor is further configured to:
identify a record for which the vector dot product between that record's incident unit propagation vector and the target incident unit propagation vector is maximized;
apply a transformation to the target field vector to generate a transformed electric field vector that is perpendicular to the identified record's incident unit propagation vector;
apply the identified record's scattering map to the transformed field vector to compute an intermediate diffracted field vector; and
apply an inverse of the transformation to the intermediate diffracted field vector to compute the field of the diffracted wave.

8. A system according to claim 6 wherein the processor is further configured to use linear interpolation.

9. A system according to claim 6 wherein the processor is further configured to compute an interpolated scattering map from the set of records and use the interpolated scattering map to compute the field of the diffracted wave.

10. A system according to claim 1 wherein the diffraction parameter sets do not include any values which represent electric or magnetic fields.

11. A system according to claim 1 wherein each diffraction parameter sets comprises at least one value which defines a property of an incident wave and/or at least one value which defines a property of a diffraction grating.

12. A system according to claim 11 wherein each diffraction parameter sets comprises a value which defines the wavelength of the incident wave and/or a value which defines an angle of incidence of the incident wave.

13. A system according to claim 12 wherein each diffraction parameters set comprises two values which define the propagation direction of the incident wave in three dimensional space.

14. A system according to claim 11 wherein the diffraction parameter set comprises:
a value which defines a period of the grating; and/or
a value which defines a slant angle of the grating; and/or
a value which defines a wall angle of the grating; and/or
a value which defines a height of the grating; and/or
a value which defines a linewidth of the grating; and/or
a value which defines the shape of the grating.

15. A system according to claim 1 wherein the processor is further configured to provide a user interface via which the input set is received.

16. A system according to claim 3 wherein the processor is further configured to provide a user interface via which the field of the diffracted wave is outputted.

17. A diffraction grating manufacturing process comprising using the system of claim 1 in manufacturing a diffraction grating.

18. A diffraction grating modelling system comprising:
a memory configured to store a database, the database comprising:
a sequence of records, each one of the sequence of records labelled by a diffraction parameter set that describes a diffraction scenario in which an incident wave is diffracted; and
a scattering map that describes a field transformation induced in that scenario, wherein the diffraction parameter sets set do not specify any fields of the incident waves;
a processor in communication with the memory, the processor configured to:
receive (i) an input diffraction parameter set which defines a target diffraction scenario in which a target incident wave is diffracted and (ii) input field data which specifies a field of the target incident wave;
search the database using the input set but not the input field data for a record matching the input set, and to access the corresponding scattering map when found; and
use the accessed scattering map to compute from the input field data a field of a diffracted wave created in the target scenario.

19. A diffraction grating manufacturing process comprising using the system of claim 18 in manufacturing a diffraction grating.

20. A method comprising:
receiving an input diffraction parameter set which defines a target diffraction scenario, the input diffraction parameter set indicating a target incident unit propagation vector;
receiving an indication of a target incident field vector for the target scenario;
accessing a database comprising a plurality of records, each labelled by a diffraction parameter set which describes a diffraction scenario and comprising a corresponding scattering map which describes a field transformation induced in that scenario, wherein the diffraction parameter set indicates an incident unit propagation vector;
identifying a record for which the vector dot product between that record's incident unit propagation vector and the target incident unit propagation vector is maximized;
applying a transformation to the target incident field vector to compute a transformed vector that is perpendicular to the identified record's incident unit propagation vector;
applying the identified record's scattering map to the transformed electric field vector to compute an intermediate diffracted field vector; and
applying an inverse of the transformation to the intermediate diffracted field vector to compute a diffracted field vector of a diffracted wave that would be created in the target scenario.

21. The method of claim 20 on a computer and using the executed program in manufacturing a diffraction grating.
